(19) United States
(12) Patent Application Publication
(10) Pub. No.: US 2019/0084521 A1
(43) Pub. Date: Mar. 21, 2019

(54) VEHICLE AIRBAG ASSEMBLY

(71) Applicant: Ford Global Technologies, LLC, Dearborn, MI (US)

(72) Inventors: S.M. Iskander Farooq, Novi, MI (US); Saeed David Barbat, Novi, MI (US); Srinivasan Sundararajan, Ann Arbor, MI (US); Mohammad Omar Faruque, Ann Arbor, MI (US); Dean M. Jaradi, Macomb, MI (US); Nirmal Muralidharan, Birmingham, MI (US)

(73) Assignee: Ford Global Technologies, LLC, Dearborn, MI (US)

(21) Appl. No.: 15/707,696

(22) Filed: Sep. 18, 2017

(51) Int. Cl. B60R 21/36; B60R 21/38

(52) U.S. Cl. CPC B60R 21/36; B60R 2021/343; B60R 21/38

(57) ABSTRACT

An assembly includes a hood. The assembly includes an airbag assembly secured to the hood. The airbag assembly includes inflatable members inflatable to an inflated position, and uninflatable panels in an alternating arrangement with the inflatable members.

### BACKGROUND

A vehicle may include an airbag deployable during a vehicle impact to absorb energy from a pedestrian outside of the vehicle during the impact. The airbag may be a component of an airbag assembly including a housing supporting the airbag, and an inflation device in communication with the airbag for inflating the airbag from an uninflated position to an inflated position.

### BRIEF DESCRIPTION OF THE DRAWINGS

FIG. 1 is a top perspective view of a vehicle including an assembly having an airbag assembly with inflatable members of the airbag assembly in an uninflated position.

FIG. 2 is a cross section view of the assembly with the members of the airbag assembly in the uninflated position.

FIG. 3 is a perspective view of the vehicle with the inflatable members of the airbag assembly in an inflated position.

FIG. 4 is a top view is a top perspective view of the vehicle with the inflatable members of the airbag assembly in the inflated position.

FIG. 5 is a cross section of one embodiment of the inflatable members in the inflated position.

FIG. 6 is a cross section of a second embodiment of the inflatable members in the inflated position.

FIG. 7 is a cross section of a third embodiment of the inflatable members in the inflated position.

FIG. 8 is a cross section of the airbag assembly with the inflatable members in the inflated position.

FIG. 9 is a block diagram of components of the vehicle.

### DETAILED DESCRIPTION

An assembly includes a hood. The assembly includes an airbag assembly secured to the hood. The airbag assembly includes inflatable members inflatable to an inflated position, and uninflatable panels in an alternating arrangement with the inflatable members.

The inflatable members in the inflated position may be elongated along longitudinal axes, and the inflatable members and uninflatable panels may be in the alternating arrangement along a lateral axis perpendicular to the longitudinal axis.

The lateral axis may extend along a cross-vehicle axis.

The assembly may include a windshield. The inflatable members in the inflated position may abut the windshield.

The uninflatable panels and the inflatable members may extend from the hood in the inflated position.

The assembly may include an inflation pipe having a plurality of ports, each port being in fluid communication with one of the inflatable members.

The assembly may include a hood lift system designed to lift the hood.

The assembly may include a computer programmed to actuate the hood lift system to lift the hood, and then to actuate the airbag assembly to inflate the inflatable members.

The assembly may include a windshield. The inflatable members in the inflated position may be between the uninflatable panels and the windshield.

The hood may include an inner panel and an outer panel, and the airbag assembly may be secured to the inner panel.

The assembly may include a pair of A-pillars spaced from each other and having a distance therebetween. The inflatable members in the inflated position and the uninflatable panels may collectively have a width that is greater than the distance between A-pillars.

One of the inflatable members in the inflated position may be spaced from one of the A-pillars by a first amount and have a first length, and another of the inflatable members in the inflated position may be spaced from the one of the A-pillars by a second amount that is greater than the first amount and may have a second length that is less than the first length.

The hood may have a centerline, and one of the inflatable members in the inflated position may be spaced from the centerline by a first amount and have a first length, and another of the inflatable members in the inflated position may be spaced from the centerline by a second amount that is less than the first amount and may have a second length that is less than the first length.

One of the inflatable members may be secured to one of the uninflatable panels and to another of the uninflatable panels at a common location.

One of the inflatable members may be secured to one of the uninflatable panels at a first location and to another of the uninflatable panels at a second location spaced from the first location.

One of the inflatable members may have a width, and one of the uninflatable panels may have a width that is less than the width of the one of the inflatable members.

The inflatable members may be spaced from each other.

The inflatable members may be spaced from each other by a distance that is less than a width of a JAMA-JARI head form impactor.

The airbag assembly may include an inflator in fluid communication with the inflatable members and supported by the hood.

The uninflatable panels may be formed of fabric.

With reference to the Figures, an assembly 20 for a vehicle 22 includes a hood 24. The assembly 20 includes an airbag assembly 26 secured to the hood 24. The airbag assembly 26 includes inflatable members 28 inflatable to an inflated position, and uninflatable panels 30 in an alternating arrangement with the inflatable members 28. The assembly 20 reduces a likelihood of injury of a person outside the vehicle 22 who contacts the vehicle 22, e.g., during an impact with the vehicle 22.

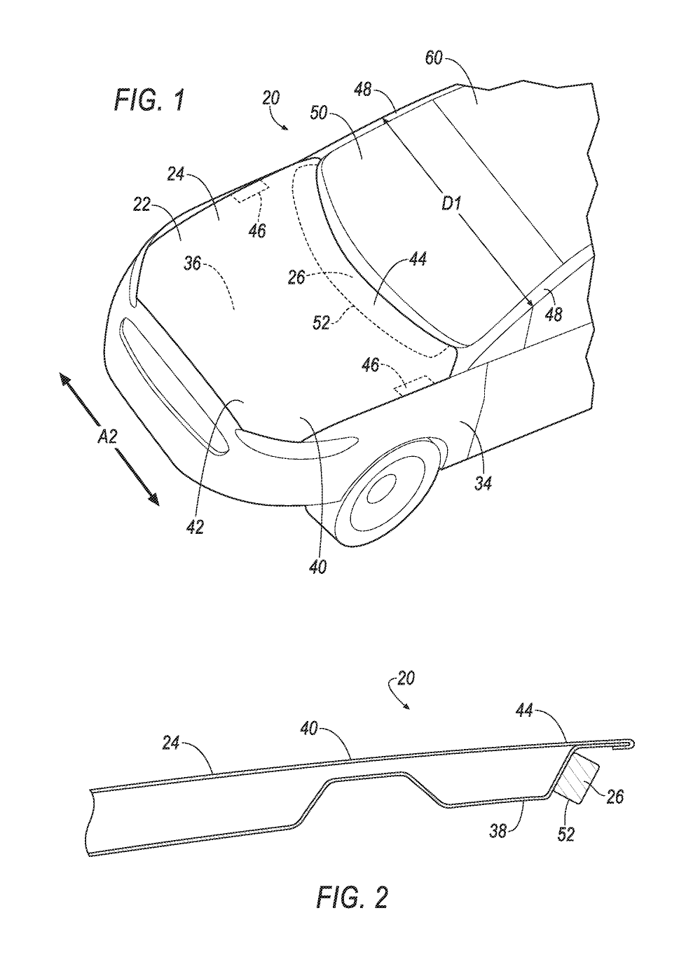

The vehicle 22, shown in FIGS. 1, 3, 4 and 9, may be any passenger or commercial automobile such as a car, a truck, a sport utility vehicle, a crossover vehicle, a van, a minivan, a taxi, a bus, etc.

The vehicle 22 may operate in an autonomous mode, a semi-autonomous mode, or a non-autonomous mode. For purposes of this disclosure, an autonomous mode is defined as one in which each of a propulsion, braking, and steering of the vehicle 22 are controlled by a computer 32; in a semi-autonomous mode the computer 32 controls one or two of the propulsion, braking, and steering of the vehicle 22; in a non-autonomous mode, a human operator controls the propulsion, braking, and steering of the vehicle 22.

The vehicle 22 has a body 34. The body 34 may be of a unibody construction. In the unibody construction, the body 34 serves as a frame of the vehicle 22, and the body is unitary, i.e., a continuous one-piece unit. As another example, the body 34 and frame may have a body-on-frame construction (also referred to as a cab-on-frame construction). In other words, the body 34 and frame are separate components, i.e., are modular, and the body 34 is supported on and affixed to the frame. Alternatively, the body 34 and frame may have any suitable construction. The body 34 and/or the frame may be formed of any suitable material, for example, steel, aluminum, etc.

The body 34 may define an engine bay 36. The engine bay 36 houses components of the vehicle 22, e.g., an engine, a radiator, a windshield washer system, air heating and cooling systems, etc. It is understood that in the case of the vehicle 22 being an electric vehicle, i.e., having no engine, the engine bay 36 may house vehicle 22 components other than the engine.

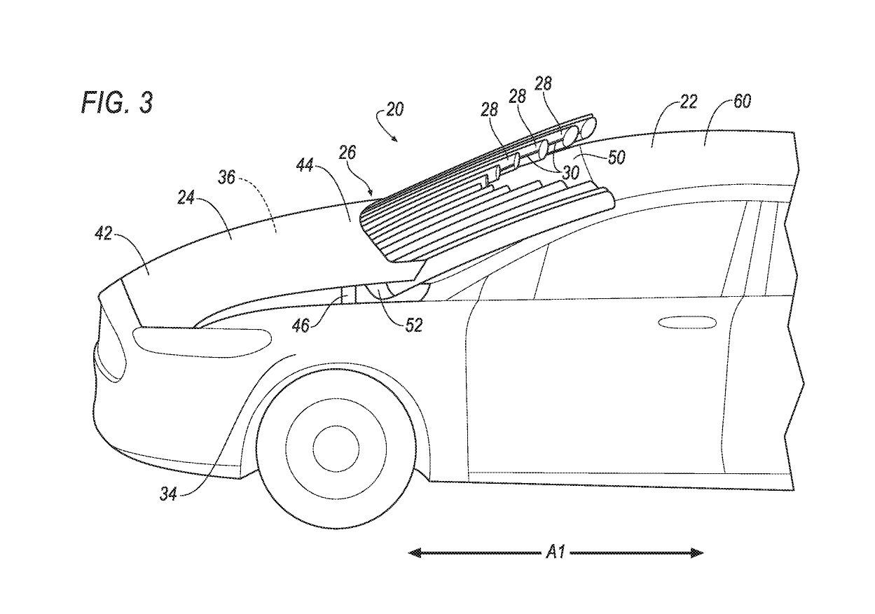

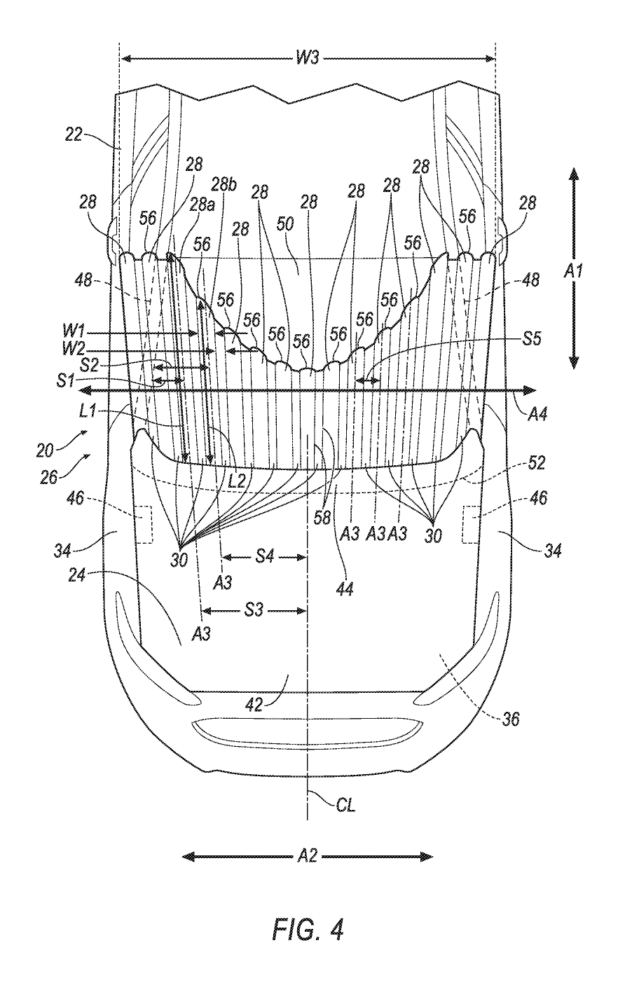

The vehicle 22 has a front-to-rear axis Al, shown in FIGS. 3 and 4, and a cross-vehicle axis A2, shown in FIGS. 1 and 4. The front-to-rear axis Al extends between a front and a rear of the vehicle 22 body 34. The cross-vehicle axis A2 extends perpendicular to the front-to-rear axis Al, e.g., between a driver side of the vehicle 22 and a passenger side of the vehicle 22.

The hood 24 may be supported the body 34. The hood 24 may cover the engine bay 36. The hood 24 may include an inner panel 38 and an outer panel 40, as shown in FIG. 2. The inner panel 38 is closer to the engine bay 36 than the outer panel 40. The outer panel 40 may provide an exterior class-A surface to the vehicle 22, i.e., a surface specifically manufactured to have a high quality, finished aesthetic appearance free of blemishes. The inner panel 38 may be secured to the outer panel 40, e.g., with one or more fasteners, via welding, etc.

The hood 24 has a front 42, a rear 44, and a centerline CL, as shown in FIG. 4. The centerline CL may extend along the front-to-rear axis Al of the vehicle 22. The front 42 and the rear 44 may be relative to the vehicle 22.

The assembly 20 may include a hood lift system 46 designed to lift the hood 24. The hood lift system 46 may be supported by the body 34. The hood lift system 46 may include various electromechanical components such as servo motors, linear actuators, etc., designed to lift the rear 44 of the hood 24 relative to the body 34, e.g., in response to an instruction from the computer 32.

The assembly 20 may include a pair of A-pillars 48. The A-pillars 48 may be part of the body 34. The pair of A-pillars 48 spaced from each other and have a distance D1 therebetween, as shown in FIG. 1. The distance D1 between the A-pillars 48 may be along the cross-vehicle axis A2.

The assembly 20 may include a windshield 50. The windshield 50 is made of transparent material, e.g., glass, plexiglass, etc. The windshield 50 protects occupants of the vehicle 22 while permitting such occupants to see through the windshield 50. The windshield 50 may be supported by the A-pillars 48.

The airbag assembly 26 may include a housing 52. The inflatable members 28 and the uninflatable panels 30 may be disposed in the housing 52 in an uninflated position. The housing 52 provides a reaction surface for the inflatable members 28 in the inflated position. The housing 52 may be formed of any material, e.g., a rigid polymer, a metal, a composite, etc.

The airbag assembly 26 is secured to the hood 24. The airbag assembly 26 may be secured to the inner panel 38. For example, the housing 52 may be secured to the inner panel 38 of the hood 24, e.g., with one or more fasteners, etc. In other words, the airbag assembly 26 may be supported by the hood 24 and may move with the hood 24 as the hood 24 moves relative to the body 34, e.g., when moved by the hood lift system 46.

The airbag assembly 26 includes the inflatable members 28. The inflatable members 28 may be formed of a woven polymer fabric or any other material. As one example, the inflatable members 28 may be formed of woven nylon yarn, for example, nylon 6-6. Other examples include polyether ether ketone (PEEK), polyetherketoneketone (PEKK), polyester, etc. The woven polymer may include a coating, such as silicone, neoprene, urethane, etc. For example, the coating may be polyorgano siloxane.

The inflatable members 28 are inflatable to the inflated position. The inflatable members 28 in the inflated position may be elongated along longitudinal axes A3, as shown in FIG. 4. Each of the longitudinal axes A3 are centered on the respective inflatable member 28. The inflatable members 28 in the inflated position extend from the hood 24, e.g., along the longitudinal axes A3. The inflatable members 28 in the inflated position may abut the windshield 50.

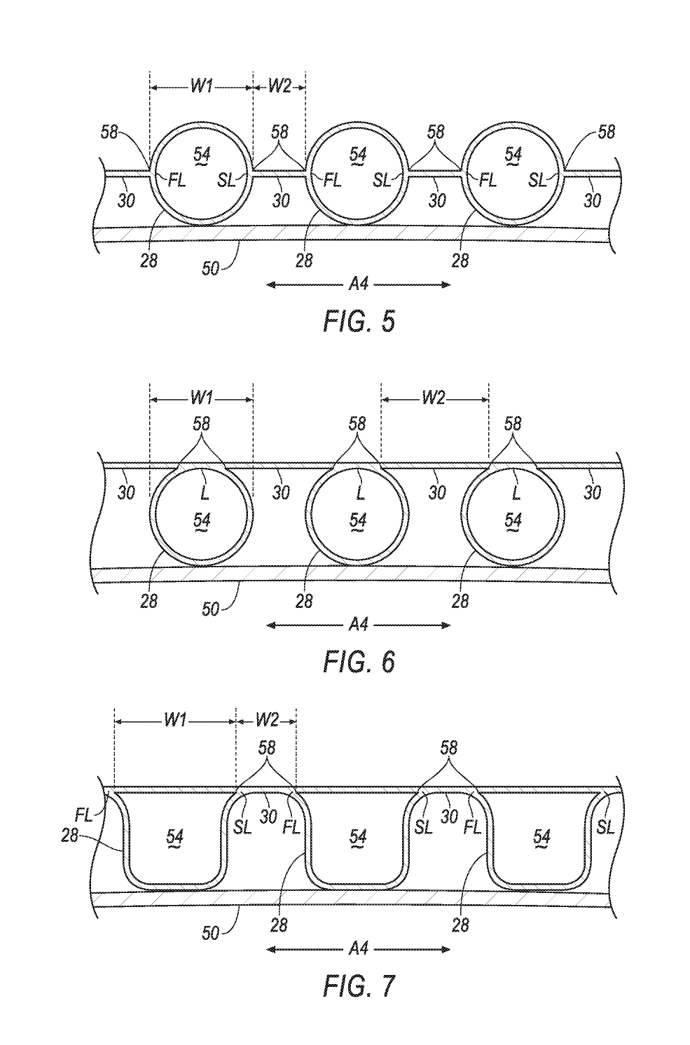

The inflatable members 28 in the inflated position may each define an inflation chamber 54, as shown in FIGS. 5-8. For example, each inflatable member 28 may be tubular in shape and surround their respective inflation chamber 54. For example, each of the inflatable members 28 in the inflated position may be circular in cross section, as shown in FIGS. 5 and 6, e.g., taken along a lateral axis A4 that is perpendicular to the longitudinal axes A3. The lateral axis A4 may extend along the cross-vehicle axis A2, as shown in FIG. 4. The tubular shape of each inflatable member 28 may be elongated along the longitudinal axes A3.

With reference to FIG. 4, each of the inflatable members 28 in the inflated position has a width W1, as shown in FIGS. 4-7. The width W1 may be along the lateral axis A4. The width W1 may be a diameter of the respective inflatable member 28.

Some of the inflatable members 28 in the inflated positions are adjacent the A-pillars 48, and some of the inflatable members 28 in the inflated position are adjacent the windshield 50. The inflatable members 28 are spaced from each other across the windshield 50 between the A-pillars 48. In other words, the inflatable members 28 are spaced from each other by various distances from the A-pillars 48. For example, at least one of the inflatable members 28, e.g., a first inflatable member 28a, in the inflated position may be spaced from one of the A-pillars 48 by a first amount S1. Another of the inflatable members 28, e.g., a second inflatable member 28b, in the inflated position may be spaced from the one of the A-pillars 48 by a second amount S2. The second amount S2 may be greater than the first amount S1.

The first inflatable member 28a in the inflated position may be spaced from the centerline CL of the hood 24 by a first amount S3. The second inflatable member 28b in the inflated position may be spaced from the centerline by a second amount S4. The second amount S4 may be less than the first amount S3.

Each of the inflatable members 28 in their inflated position may include a distal end 56. The distal ends 56 are spaced from the hood 24. Each inflatable member 28 is elongated from the hood 24 to the distal end 56 in the inflated position.

The inflatable members 28 may have the different lengths from the hood 24 to the distal ends 56. For example, the first inflatable member 28a in the inflated position may have a first length L1 from the hood 24 to the distal ends 56. The second inflatable member 28b in the inflated position may have a second length L2 from the hood 24 to the distal ends 56. The second length L2 may be less than the first length L1.

The various lengths of the inflatable members 28 and the spacing of the inflatable members 28 may be such that that the airbag assembly 26 helps to reduce impact for areas of the vehicle 22 that are most likely to be in contact with a pedestrian, e.g., an area along the windshield 50 near the hood 24 and the A-pillars 48. To put it another way, the closer any particular inflatable member 28 is to the centerline CL, the shorter the length of inflatable member 28. For example, outermost inflatable members 28, relative to the centerline CL, may have the greatest lengths, e.g., to cover the A-pillars 48.

The inflatable members 28 in the inflated position may be spaced from each other. The inflatable members may be spaced from each other by a distance that is less than a width of a JAMA-JARI head form impactor. For example, the longitudinal axes A3 of adjacent inflatable members 28 may be spaced from each other by the distance that is less than a width of a JAMA-JARI head form impactor. For example, the spacing may be such that each of the adjacent members 28 absorbs energy from the head form impactor. To put it another way, the spacing may be such that the head form impactor does not fit between the adjacent inflatable members 28, e.g., without being slowed by the adjacent inflatable members 28 before contacting windshield 50.

The airbag assembly 26 includes the uninflatable panels 30. The uninflatable panels 30 may be formed of woven polymer, fabric, or any other material, as described for the inflatable members 28. The uninflatable panels 30 may be formed of a same type of material as the inflatable members 28.

The uninflatable panels 30 are in an alternating arrangement with the inflatable members 28. For example, each uninflatable panel 30 may be disposed between a pair of inflatable members 28. The inflatable members 28 and uninflatable panels 30 are in the alternating arrangement along the lateral axis A4. For example, each uninflatable panel 30 may include a pair of edges 58 spaced from each other along the lateral axis A4. One of the pair of edges 58 may be secured to one of the inflatable members 28, and the other of the pair of edges 58 may be secured to another of the inflatable members 28. The edges 58 may extend along the longitudinal axes A3.

The uninflatable panels 30 extend from the hood 24, e.g., while the inflatable members 28 are in the inflated positions. The uninflatable panels 30 may extend from the hood 24 towards a roof 60 of the vehicle 22. The uninflatable panels 30 may be elongated along the longitudinal axes A3.

Each of the uninflatable panels 30 may have a width W2. The width W2 may be along the lateral axis A4. The width W2 may be between where the uninflatable panel 30 is secured to the inflatable members 28, as shown in FIGS. 5-7, e.g., between the edges 58 of the uninflatable panel 30. The width W2 of one of the uninflatable panels 30 is less than the W1 width of the one of the inflatable members 28. To put it another way, the width W1 of the inflatable members 28 may be greater than the width W2 of the uninflatable panels 30.

The inflatable members 28 in the inflated position are between the uninflatable panels 30 and the windshield 50. For example, as shown in FIGS. 6 and 7, the inflatable members 28 in the inflated position may be supported on the windshield 50, and the uninflatable panels 30 may be supported on the inflatable members 28. When the inflatable members 28 are in the inflated position, the uninflatable panels 30 are external to the inflation chambers 54 of the inflatable members 28. When the inflatable members 28 are in the inflated position, the inflatable members 28 may pull the uninflatable panels 30 taught between each respective inflatable member 28.

One of the inflatable members 28 may be secured to one of the uninflatable panels 30 and to another of the uninflatable panels 30 at a common location L. For example, as shown in FIG. 6, the uninflatable panels 30 located on opposite sides of one of the inflatable members 28 may secure to such inflatable member 28 at the common location L and extend tangentially from the circular cross section of such inflatable member 28.

One of the inflatable members 28 may be secured to one of the uninflatable panels 30 at a first location FL and to another of the uninflatable panels 30 at a second location SL spaced from the first location FL. For example, as shown in FIG. 5, the first location FL may be separated from the second location SL by 180 degrees of angular displacement relative to the circular cross section of the inflatable member 28. For example, as shown in FIGS. 5 and 7, the first location FL may be spaced from the second location SL along the lateral axis A4.

The inflatable members 28 in the inflated position and the uninflatable panels 30 collectively have a width W3, as shown in FIG. 4. The width W3 may be along the lateral axis A4. The width W3 may be between the outermost inflatable members 28. The width W3 may be greater than the distance D1 between A-pillars 48.

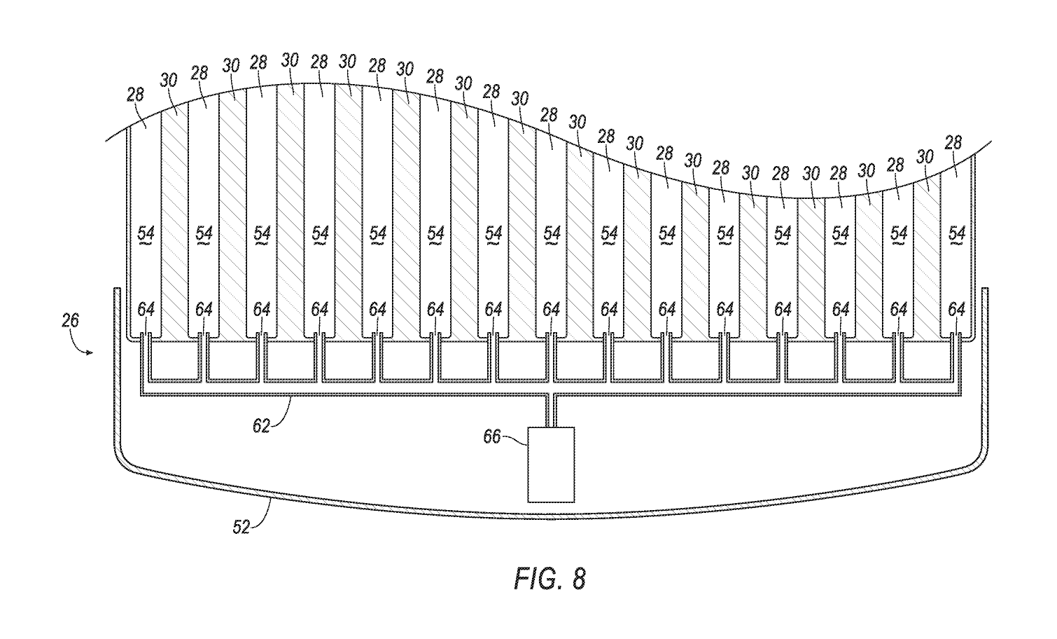

The assembly 20 may include an inflation pipe 62, as shown in FIG. 8. The inflation pipe 62 may be made of metal, plastic, or any other suitable material. The inflation pipe 62 may be supported by the hood 24, e.g., via the housing 52. The inflation pipe 62 may be disposed within the housing 52. The inflation pipe 62 provides gas to the inflatable members 28. The inflation pipe 62 may have a plurality of ports 64. Each port 64 may be in fluid communication with one of the inflatable members 28. To put it another way, one of the plurality of ports 64 may be in fluid communion with one of the inflatable members 28, while another of the plurality of ports 64 may be in fluid communication with another of the inflatable members 28, and so on.

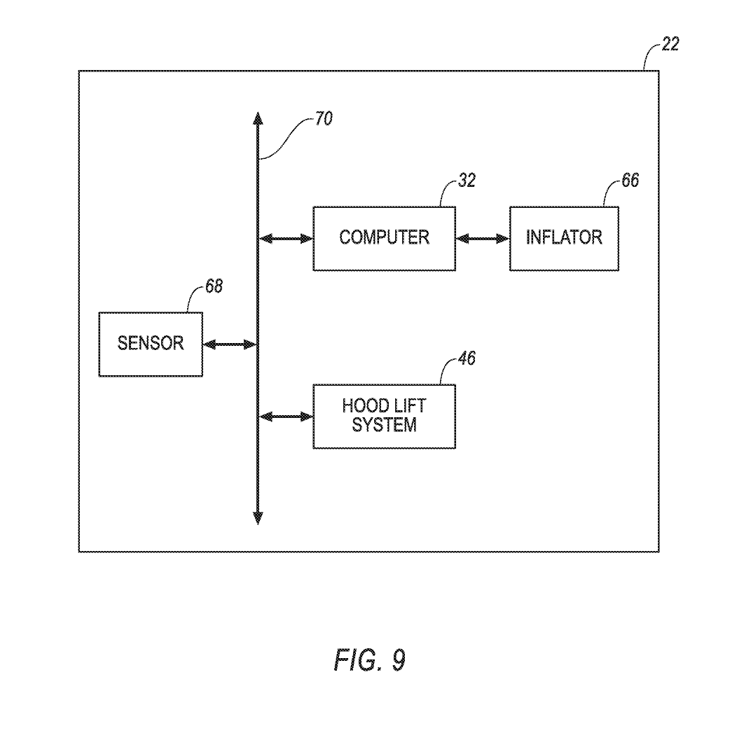

The airbag assembly 26 may include an inflator 66, as shown in FIGS. 8 and 9. The inflator 66 is in fluid communication with the inflatable members 28, e.g., via the inflation pipe 62. The inflator 66 may be, for example, a pyrotechnic inflator that uses a chemical reaction to drive inflation medium to the members 28. The inflator 66 may be of any suitable type, for example, a cold-gas inflator. The inflator 66 may be supported by the housing 52, the hood 24, or in or on any other suitable location of the vehicle 22. The inflator 66 may be disposed within the housing 52.

The vehicle 22 may include at least one impact sensor 68 for sensing impact of the vehicle 22, and the computer 32 in communication with the impact sensor 68 and the inflator 66, as shown in FIG. 9. The computer 32 may activate the inflator 66, e.g., provide an impulse to a pyrotechnic charge of the inflator 66 when the impact sensor 68 senses an impact of the vehicle 22. Alternatively or additionally to sensing impact, the impact sensor 68 may be designed to sense impact prior to impact, i.e., pre-impact sensing.

The impact sensor 68 may be in communication with the computer 32. The impact sensor 68 is designed to detect an impact to the vehicle 22. The impact sensor 68 may be of any suitable type, for example, post-contact sensors such as accelerometers, pressure sensors, and contact switches; and pre-impact sensor 68s such as radar, LIDAR, and vision-sensing systems. The vision-sensing systems may include one or more cameras, CCD image sensors, CMOS image sensors, etc. The impact sensor 68 may be located at numerous points in or on the vehicle 22.

The computer 32, the hood lift system 46, and the impact sensor 68 may be connected to a communication bus 70, such as a controller area network (CAN) bus, of the vehicle 22. The computer 32 may use information from the communication bus 70 to control the activation of the inflator 66 and the hood lift system 46. The inflator 66 may be connected directly to the computer 32, as shown in FIG. 9, or the inflator 66 may be connected via the communication bus 70.

The computer 32 is programmed to actuate the hood lift system 46 to lift the hood 24, and then to actuate the airbag assembly 26 to inflate the inflatable members 28. For example, the computer 32 may be programmed to transmit an instruction to the hood lift system 46 instructing actuation of the hood lift system 46, e.g., the via communication bus 70. Next, the computer 32 may transmit an instruction to the inflator 66 instructing actuation to inflate the inflatable members 28.

The computer 32 may be a microprocessor-based computer 32 implemented via circuits, chips, or other electronic components. For example, the computer 32 may include a processor, a memory, etc. The memory of the computer 32 may include memory for storing programming instructions executable by the processor as well as for electronically storing data and/or databases.

In operation, the inflatable members 28 are in the uninflated position under normal operating conditions of the vehicle 22. In the event of an impact, the impact sensor 68 may detect the impact and transmit a signal through the communication bus 70 to the computer 32. Upon receiving such signal, the computer 32 may first transmit an instruction to the hood lift system 46 to lift the rear of the hood 24. Next, the computer 32 may transit a signal to the inflator 66. Upon receiving the signal, the inflator 66 may discharge and inflate the inflatable members 28 with the inflation medium to the inflated position. The impact may be with a pedestrian. In such situation, the inflatable members 28 and the uninflatable panels 30 help to cushion such impact. For example, the pedestrian may contact the inflatable members 28 and the uninflatable panels 30 instead of the windshield 50 and/or the A-pillar 48. The inflatable members 28 and the uninflatable panels 30 absorb energy from such impact, thereby reducing a likelihood of injury of the pedestrian.

The adjectives “first” and “second” are used throughout this document as identifiers and are not intended to signify importance or order.

The preposition “along” is used through this document to mean having a same contour as a line and/or surface of a subject used therewith. For example, along an axis means parallel to a line or plane that may be defined by such axis, including being spaced from such line or plane.

It is to be understood that the various geometric descriptions of the airbags, e.g., extending along an axis, etc., are limited in their precision by the flexible nature of the airbags in the inflated position.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. An assembly comprising:
a hood;
an airbag assembly secured to the hood; and
the airbag assembly including inflatable members inflatable to an inflated position, and uninflatable panels in an alternating arrangement with the inflatable members.

2. The assembly of claim 1, wherein the inflatable members in the inflated position are elongated along longitudinal axes, and the inflatable members and uninflatable panels are in the alternating arrangement along a lateral axis perpendicular to the longitudinal axis.

3. The assembly of claim 2, wherein the lateral axis extends along a cross-vehicle axis.

4. The assembly of claim 1, further comprising a windshield, wherein the inflatable members in the inflated position abut the windshield.

5. The assembly of claim 1, wherein the uninflatable panels and the inflatable members extend from the hood in the inflated position.

6. The assembly of claim 1, further comprising an inflation pipe having a plurality of ports, each port being in fluid communication with one of the inflatable members.

7. The assembly of claim 1, further comprising a hood lift system designed to lift the hood.

8. The assembly of claim 7, further comprising a computer programmed to actuate the hood lift system to lift the hood, and then to actuate the airbag assembly to inflate the inflatable members.

9. The assembly of claim 1, further comprising a windshield, wherein the inflatable members in the inflated position are between the uninflatable panels and the windshield.

10. The assembly of claim 1, wherein the hood includes an inner panel and an outer panel, and the airbag assembly is secured to the inner panel.

11. The assembly of claim 1, further comprising a pair of A-pillars spaced from each other and having a distance therebetween, wherein the inflatable members in the inflated position and the uninflatable panels collectively have a width that is greater than the distance between A-pillars.

12. The assembly of claim 11, wherein one of the inflatable members in the inflated position is spaced from one of the A-pillars by a first amount and has a first length, and another of the inflatable members in the inflated position is spaced from the one of the A-pillars by a second amount that is greater than the first amount and has a second length that is less than the first length.

13. The assembly of claim 1, where in the hood has a centerline, and one of the inflatable members in the inflated position is spaced from the centerline by a first amount and has a first length, and another of the inflatable members in the inflated position is spaced from the centerline by a second amount that is less than the first amount and has a second length that is less than the first length.

14. The assembly of claim 1, wherein one of the inflatable members is secured to one of the uninflatable panels and to another of the uninflatable panels at a common location.

15. The assembly of claim 1, wherein one of the inflatable members is secured to one of the uninflatable panels at a first location and to another of the uninflatable panels at a second location spaced from the first location.

16. The assembly of claim 1, wherein one of the inflatable members has a width, and one of the uninflatable panels has a width that is less than the width of the one of the inflatable members.

17. The assembly of claim 1, wherein the inflatable members are spaced from each other.

18. The assembly of claim 1, wherein the inflatable members are spaced from each other by a distance that is less than a width of a JAMA-JARI head form impactor.

19. The assembly of claim 1, wherein the airbag assembly includes an inflator in fluid communication with the inflatable members and supported by the hood.

20. The assembly of claim 1, wherein the uninflatable panels are formed of fabric.
